(19) United States
(12) Patent Application Publication
(10) Pub. No.: US 2008/0189209 A1
(43) Pub. Date: Aug. 7, 2008

(54) Real-Time Funds Transfer

(75) Inventors: Nancy Loomis, San Diego, CA (US); Peter Rae, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/734,451

(22) Filed: Apr. 12, 2007

Related U.S. Application Data
(63) Continuation-in-part of application No. 11/671,219, filed on Feb. 5, 2007.

(51) Int. Cl. G06Q 40/00

(52) U.S. Cl. 705/44

(57) ABSTRACT

A computerized method for transferring funds from a first account at an initiating financial institution to a second account at a receiving financial institution over an automated teller machine (ATM) network is disclosed. The method may include receiving a funds transfer request from a consumer to transfer funds from the first account at the initiating financial institution to the second account at the receiving financial institution. Authenticating the consumer for a transactions related to the first account at the initiating financial institution may also be included. The system may verify that the funds available in the first account at the initiating financial institution is greater than or equal to the fund transfer amount. Finally, the method debits funds from the first account at the initiating financial institution; and credits funds to the second account at the receiving financial institution.

### CROSS-REFERENCE TO RELATED APPLICATION

This application is a continuation-in-part and claims the benefit of co-pending, commonly assigned U.S. patent application Ser. No. 11/671,219, filed Feb. 5, 2007, entitled “Authentication Of PIN-Less Transactions,” the entire disclosure of which is herein incorporated by reference for all purposes.

### BACKGROUND OF THE INVENTION

This disclosure relates in general to fund transfers and, but not by way of limitation, to fund transfers between financial accounts over an automated teller machine (ATM) network amongst other things.

In this context Financial networks, refer to financial networks that primarily process ATM and point-of-sale transactions that typically require a personal identification number (PIN) entry for authentication, as opposed to networks that primarily require signatures for cardholder authentication.

The development of the Internet and Internet financial transactions in particular has led to increased developments in Internet security, secure transactions in eCommerce, and secure fund transfers and transactions. Most Internet transactions are completed using credit cards, signature debit cards or other payment schemes such as PayPal or Google Checkout. Due to the high cost of introducing PIN-protecting hardware or software, ATM/Debit card payments or fund transfers that require PIN entry have been limited on the Internet or through mobile devices. Financial networks do allow ATM/Debit cardholders to make card payments or transfers without entering a PIN to companies that cardholders already have relationships with, such as utilities. Financial network transfers are typically authenticated, often using a PIN, which is authorized at a financial institution.

Due to the heightened risk related to PIN entry on the internet along with the growth of Internet financial transactions, there is a general need for a technical improvements to fund transfers using a financial network.

### BRIEF SUMMARY OF THE INVENTION

A computerized method for transferring funds from a first account at an initiating financial institution to a second account at a receiving financial institution over an automated teller machine (ATM) or electronic funds transfer (EFT) network is disclosed. The method may include receiving a funds transfer request from a consumer. The funds transfer requests may include a request to transfer funds from the first account at the initiating financial institution to the second account at the receiving financial institution. The fund transfer request may include a fund transfer amount, and the funds transfer request may be received from the consumer over the Internet. The consumer may be authenticated for a transaction related to the first account by the initiating financial institution. The initiating financial institution may verify that the funds available in the first account at the initiating financial institution is greater than or equal to the fund transfer amount. The fund transfer amount may be debited from the first account at the initiating financial institution. The fund transfer amount may be credited at the second account at the receiving financial institution.

The method may further include sending the funds transfer request to a financial network host computer system. The method may also include receiving, at the initiating financial institution and the receiving financial institution a net settlement from the financial network host computer system. The method may also send a message to the consumer that the fund transfer was completed. The fund transfer request may be received at the initiating financial institution, the receiving financial institution, and/or a third-party financial institution. The consumer may be authenticated using a biometric sample; a password, a private key, a public key, and/or an operating system scan. The authentication may or may not require a PIN.

The first account at the initiating financial institution may include an account associated with an ATM/debit card or a stored value card. The fund transfer may occur over a financial network, such as the STAR® network, the NYCE® network, and/or the PULSE® network. The consumer may send a funds transfer request from an ATM, a mobile device, a mobile phone, a smart phone, a computer, a telephone, a kiosk, and/or a teller at a financial institution. A net settlement may be sent to the initiating financial institution and/or the receiving financial institution.

A computerized method for transferring funds from a first account at an initiating financial institution to a second account at a receiving financial institution over a financial network is also disclosed. The method may include receiving a funds transfer request over a telephone network from a consumer at a third-party institution system. The funds transfer requests may include a request to transfer funds from the first account at the initiating financial institution to the second account at the receiving financial institution, and the fund transfer request may include a fund transfer amount. The consumer may be authenticated for a transactions related to the first account at the initiating financial institution at the third-party institution. The initiating financial institution may verify that the funds available in the first account at the initiating financial institution is greater than or equal to the fund transfer amount may be requested. The fund transfer amount may be debited from the first account at the initiating financial institution and the funds transfer amount may be credited to the second account at the receiving financial institution.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components.

FIG. 1 shows a block diagram of a fund transfer system over the Internet according to one embodiment of the invention.

FIG. 2 shows a flowchart of a fund transfer process according to one embodiment of the invention.

FIG. 3 shows a flowchart of a fund transfer process according to one embodiment of the invention.

FIG. 4 shows a block diagram of a fund transfer system utilizing a third-party institution according to one embodiment of the invention.

FIG. 5 shows a flowchart of a fund transfer process according to one embodiment of the invention.

FIG. 6 shows a block diagram of a fund transfer system using an automated teller machine (ATM) according to one embodiment of the invention.

FIG. 7 shows a flowchart of a fund transfer process according to one embodiment of the invention.

FIG. 8 shows a block diagram of a fund transfer system initiated at an initiating financial institution over a financial network according to one embodiment of the invention.

FIG. 9 shows a flowchart of a fund transfer process according to one embodiment of the invention.

FIG. 10 shows a block diagram of a fund transfer system using a mobile device according to one embodiment of the invention.

FIG. 11 shows a block diagram of a fund transfer system using a telephone according to one embodiment of the invention.

### DETAILED DESCRIPTION OF THE INVENTION

This description provides exemplary embodiments only, and is not intended to limit the scope, applicability or configuration of the invention. Rather, the ensuing description of the embodiments will provide those skilled in the art with an enabling description for implementing embodiments of the invention. Various changes may be made in the function and arrangement of elements without departing from the spirit and scope of the invention as set forth in the appended claims.

Thus, various embodiments may omit, substitute, or add various procedures or components as appropriate. For instance, it should be appreciated that in alternative embodiments, the methods may be performed in an order different than that described, and that various steps may be added, omitted or combined. Also, features described with respect to certain embodiments may be combined in various other embodiments. Different aspects and elements of the embodiments may be combined in a similar manner.

It should also be appreciated that the following systems, methods, and software may be a component of a larger system, wherein other procedures may take precedence over or otherwise modify their application. Also, a number of steps may be required before, after, or concurrently with the following systems, methods, or software.

Systems, methods, and software are described for transferring funds from account to account over a financial network, such as a financial network. Embodiments of the invention rely on and trust enrollment and authentication schemes established, maintained and performed by consumers wishing to make a fund transfer between accounts. In general, embodiments of the invention provide for systems, methods and software for authenticating accounts, such as PIN-enabled or similar accounts, for a fund transfer. PIN-less authentication schemes are disclosed by U.S. patent application Ser. No. 11/671,219 filed Feb. 5, 2007, entitled Authentication of PIN-less Transactions, which is hereby incorporated by reference in its entirety for all purposes.

One embodiment of the invention provides for transferring funds from an account to another account over an EFT network, such as an ATM network. The fund transfer request may be received through the Internet, over a mobile phone network, over a telephone network, in person at an agent or financial institution location, through a telephone network, such as a public switched telephone network, at a kiosk, at an ATM, etc.

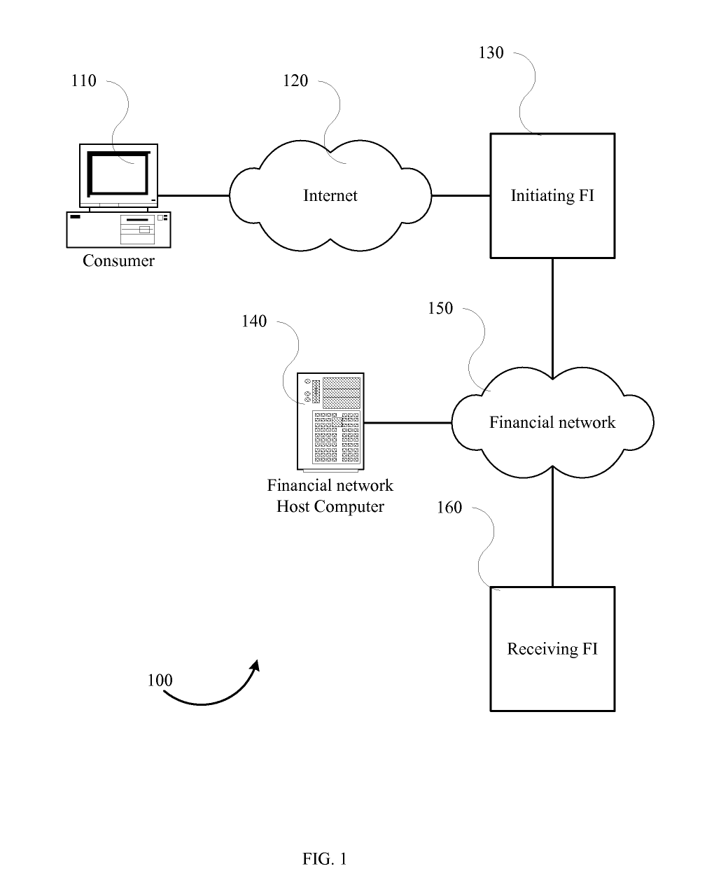

FIG. 1 shows a fund transfer system 100 according to one embodiment of the invention. A consumer 110 using a computer may access an initiating financial institution 130 over the Internet 120. The consumer 110 may access the initiating financial institution 130 over the Internet 120, an Intranet, a wide area network, a virtual private network, a public switch telephone network (PSTN), in person at an agent or teller location, at a kiosk, at an ATM, through a telephone, through a mobile phone network or through a mobile device. The Internet may include both wired and wireless connectivity.

The initiating financial institution 130 may be connected to a financial network 150, such as, for example, an EFT or ATM network. The financial network 150 may be hosted or managed by a financial network host computer 160. The financial network host computer 140 may include, for example, one or more server computers, workstations, web servers, or other suitable computing devices. The financial network host computer system 110 may be fully located within a single facility or distributed geographically, in which case a financial network, the Internet, the financial network 150, or other Network, may be used to integrate different components. A financial network host computer system 160 may comprise any computing device configured to process, manage, complete, analyze, or otherwise address a request to authenticate a cardholder, a request to authorize a PIN-less transaction card transaction, a request to notify financial institutions of compromised accounts, request authentication for a cardholder using a transaction card from a financial institution, receive physical identifiers from the cardholder, retrieve and compare physical identifiers though a network or directly, as well as other similar tasks. A receiving financial institution 160 is also shown connected to the financial network 150.

Embodiments of the invention refer to initiating financial institutions, receiving financial institutions, first financial institutions, second financial institutions, and third-party financial institutions that may more generally be referred to as financial institutions These financial institutions may be, for example, a bank, a credit union, a savings and loan, a credit card company, an investment institution, a brokerage firm, a financial services company, a state licensed money transmitter, a loan administrator, a federally licensed money transmitter, an e-commerce institution, an e-commerce merchant, a credit institution, a flexible spending account provider, or any other institution the may have access to a financial network or the Internet, provide an account that may be authenticated, or provide PIN enabled cards or accounts. For example a financial institution may include PayPal®, E*TRADE®, Merrill Lynch Online®, Wells Fargo Bank®, Countrywide Home Loans®, The Student Loan People®, Amazon.com®, Google Checkout®, etc. The financial institutions may maintain accounts for example, checking accounts, savings accounts, stored value accounts, brokerage accounts, shopping accounts, credit card accounts, investment accounts, etc.

Embodiments of the invention may also include intermediary processors between financial institutions and the financial network. These processors may include issuing and acquiring processors that ensure the proper routing of funds between the financial institutions and the financial network.

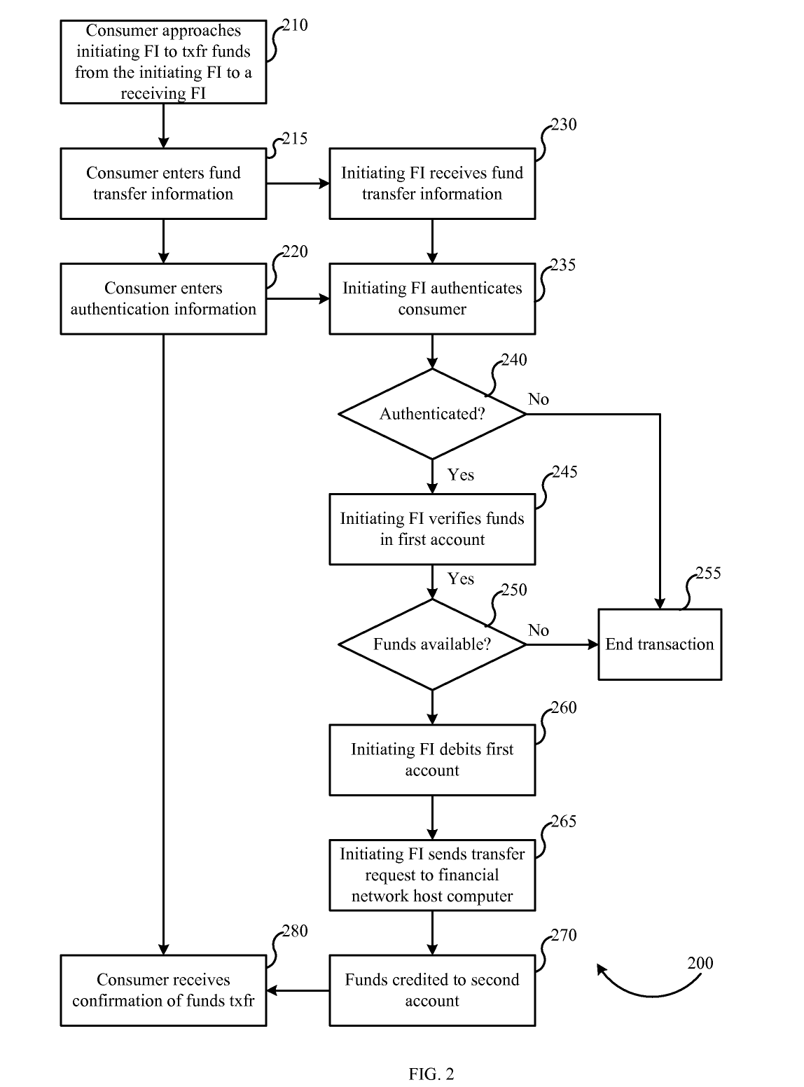

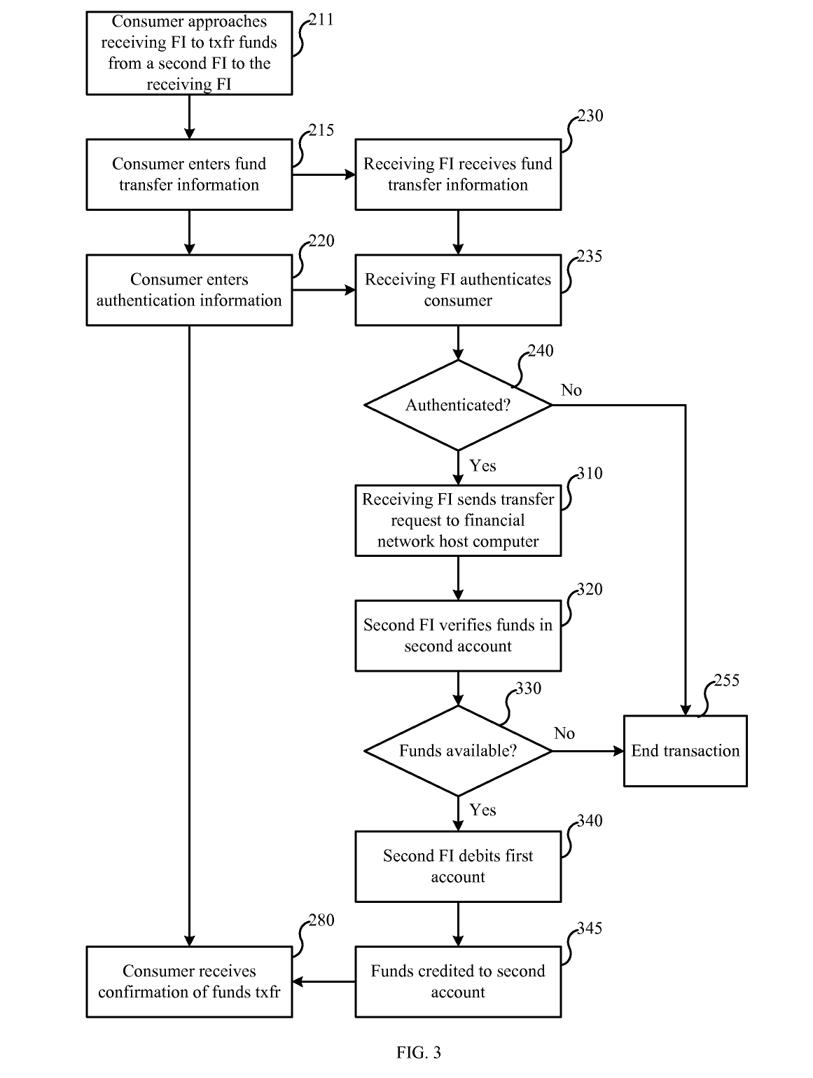

The system 100 described in regard to FIG. 1, may be used to implement the processes shown in FIGS. 2 and 3. Turning first to FIG. 2, a flow chart 200 showing a method of transferring funds from a first account at an initiating financial institution 130 to a second account at a receiving financial institution 160 according to one embodiment of the invention. The first account and/or second account may be held by the same individual or different individuals. A consumer may request a fund transfer from the first account at the initiating financial institution 130 to the second account at the receiving financial institution 160, at block 210, by pointing a web browser, for example, on the consumer's computer to the initiating financial institution's 130 web page. The fund transfer request may include a fund transfer amount. The consumer may enter fund transfer information at block 215. The fund transfer information may then be received at the initiating financial institution 130 at block 230. The initiating financial institution 130 may then require authentication of the consumer.

The consumer may then enter authentication information at block 220. The authentication information may be received at the initiating financial institution 130 at block 235. Authentication information may include a personal identification number (PIN). A PIN can be a number, a series of numbers, letters, characters, or any combination thereof used as a security instrument to authenticate a cardholders Authentication information may also include a physical identifier, such as, for example, a biometric sample, a computer scan, a security question, a PC signature, an IP address, or the like. Once the authentication information is passed on to the initiating financial institution 130, the initiating financial institution 130 confirms whether authentication information matches the stored authentication information. Other embodiments may include public-key private-key encryption of the authentication information or other cryptographic techniques to secure the authentication information.

The system then confirms the authentication. If the consumer is not authenticated, the transaction ends at block 255. Otherwise, the transaction continues. The initiating financial institution 130 may then verify that funds are available for the specified fund transfer at block 245. The initiating financial institution 130 may check that funds greater than or equal to the fund transfer amount are available in the account. If the funds are not available, as determined at block 250, the transaction ends at block 255.

If the funds are available, the initiating financial institution 130 debits the fund transfer amount from the first account at the initiating financial institution 130 at block 260. At block 265 the transfer request is sent to the financial network host computer. At block 270 the receiving financial institution 160 may credit the second account the fund transfer amount. The receiving financial institution may also approve or disapprove crediting the second account prior to crediting the second account. The consumer may then receive a confirmation message that the funds were transferred at block 280.

The financial network host computer may settle the accounts through a net settlement. For example, at the end of the day the financial network host computer may settle all the fund transfers that occurred between each financial institution during the day. During this net settlement, the financial network will effectively debit the fund transfer amount from the initiating financial institution and effectively credit the fund transfer amount to the receiving financial institution. After the net settlement the initiating financial institution and the receiving financial institution may allocate the funds as needed depending on their institutional protocols. While the net settlement may not occur until after the fund transfer request has been sent to the financial network, the receiving financial institution may immediately guarantee the availability of the funds in the second account until settlement with financial network host computer. Likewise, the initiating financial institution may immediately debit the first account prior to the net settlement. Of course, the initiating financial institution and/or the receiving financial institution may delay the debiting, crediting or guaranteeing of the funds.

FIG. 3 shows a flow chart showing a method of transferring funds 300 from a second financial institution 160 to a receiving financial institution 130 according to another embodiment of the invention. In this embodiment, the consumer approaches the receiving financial institution 130 to have funds transferred from a second financial institution 160 to the receiving financial institution 130. The consumer chooses to make the desired transaction at block 211. The consumer then enters fund transfer information and authentication information at blocks 215, 220. The receiving financial institution 130 receives the fund transfer information and the authentication information at blocks 230. The receiving financial institution 130 then authenticates the consumer at 235. Authentication of a consumer for a fund transfer from a second financial institution 160 to a receiving financial institution 130, may require sharing of authentication information between the two financial institutions. The second financial institution 160 may perform the authentication and send the results to the receiving financial institution 130, or the second financial institution 160 may send authentication information to the receiving financial institution 130 that may be used to authenticate the consumer. Moreover, a third-party may authenticate the consumer.

If the authentication is not successful at block 240, then the transaction ends at block 255. Otherwise, the receiving financial institution 130 sends a fund transfer request to the financial network at block 310. Through the financial network, the second financial institution 160 receives the fund transfer request including the fund transfer amount. If the funds are not available in the second account or the second financial institution denies the transfer the transaction ends at block 255. Otherwise, the funds are debited from the second account at the second financial institution at block 160. The funds transfer request is the sent to the financial network host computer. Funds may then be credited to the first account at the receiving financial institution 130. A net settlement may occur at some point, whereupon the financial network host computer settles the debts and credits at the financial institutions. The consumer may be notified whether the transaction was successful or not, at block 280.

Embodiments of the invention may allow a consumer to schedule recurring fund transfers between accounts. For example, a consumer may schedule to have funds transferred from a checking account at one financial institution to a savings account at another financial institution every month. In another embodiment the transfer may occur every week, every two weeks or every 15 days as specified by the consumer. In another embodiment of the invention, the account the funds are being transferred from is a PIN-enabled account. The authentication scheme may include using the PIN or through other means as described in U.S. patent application Ser. No. 11/671,219 filed Feb. 5, 2007, entitled “Authentication of PIN-less Transactions”, which is hereby incorporated by reference in its entirety for all purposes. Authentication may proceed without authentication with a PIN.

In another embodiment of the invention, the fund transfer request may send a single message that initiates the fund transfer between the accounts. In another embodiment, a single message is sent to the receiving financial institution 130 or the financial network host computer. The message may be an ISO 8583 200 message or the like. Moreover, embodiments of the invention may produce real-time fund transfers that debit and/or credit the appropriate accounts in substantially real-time. In other embodiments, the funds are transferred to and from the accounts within 10 minutes. In other embodiments, the funds are transferred in less than one hour. In other embodiments, the funds are transferred in less than one day.

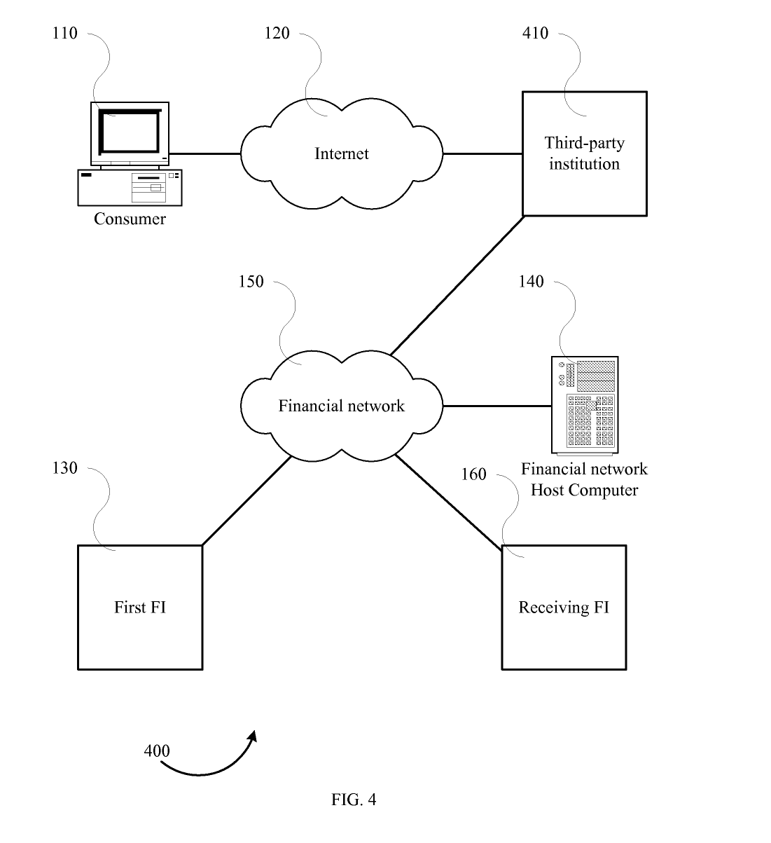

FIG. 4 shows a block diagram of a fund transfer system 400 utilizing a third-party institution 410 according to one embodiment of the invention. The third-party institution 410 may facilitate a fund transfer between a first account at a first financial institution 130 and a second account at a receiving financial institution 160. A consumer 110 may access a third-party institution 410, for example, over the Internet 120. The third-party financial institution 410 may include a money transmitter or an Internet money transfer institution. The third-party financial institution 410 may be an Internet based institution. The third-party institution 410 may also be an institution, such as, for example, a financial services company, a third-party bank or credit union, a savings institution, an investment institution, a fund transfer institution, a credit card company, a debit card company, a retail store, an online payment institution, etc. The third-party financial institution 410 may receive a fund transfer request from the consumer 110 and may authenticate the consumer 110 for fund transfers. The third-party institution may communicate authentication information through a network, such as a financial network 150, to and/or from the first and/or receiving financial institutions 130, 160.

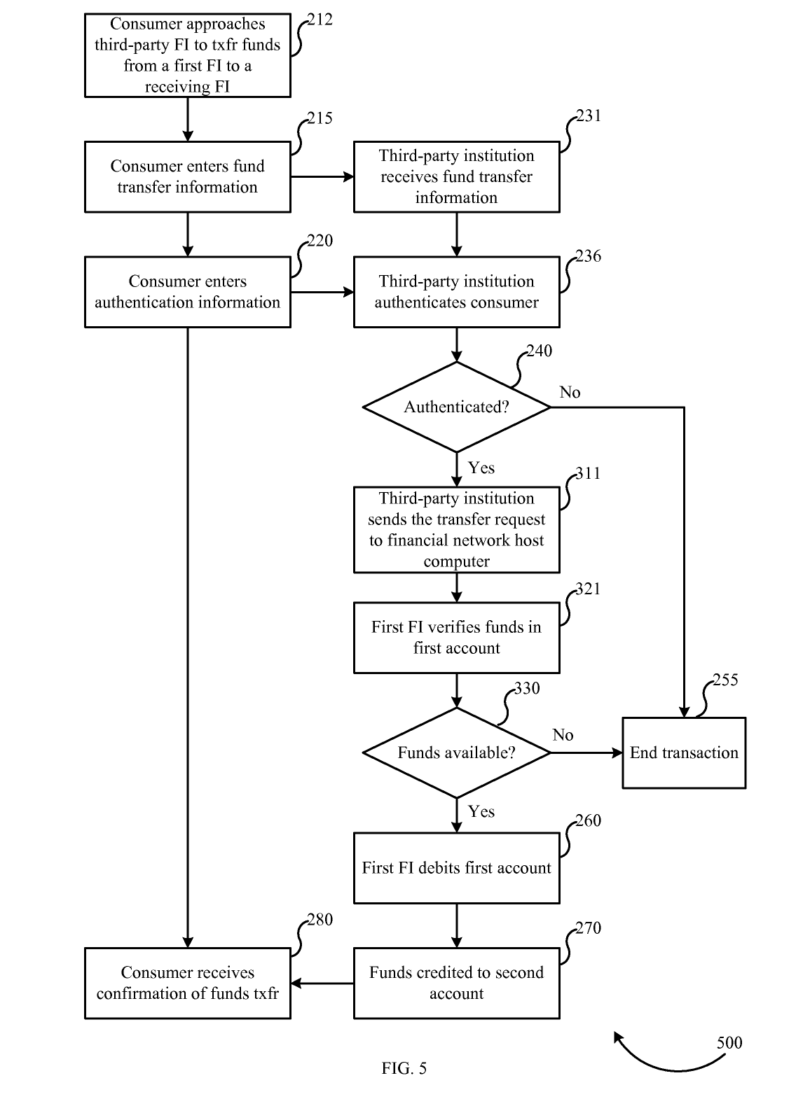

FIG. 5 shows a flowchart of a fund transfer process 500 according to one embodiment of the invention. A consumer 110 approaches a third-party institution 410 to transfer funds from a first account at a first financial institution 130 to a second account at a receiving financial institution 160 at block 212. The consumer 110 enters fund transfer information at block 215, including, for example, account numbers, financial institution information, routing numbers, account holder names, and/or fund transfer amount. This information is received by the third-party institution at block 231. The consumer may then enter authentication information at block 220, which is received at the third-party institution at block 236. The consumer may be prompted for this authentication information by the third-party institution. Authentication may included communicating with the first financial institution 130, the receiving financial institution 160, and/or the financial network host computer 140 for authentication. The third-party institution may also charge a fee from the consumer, and require payment of the fee at anytime in the process. Payment of the fee may also be deducted from the first and/or second account.

If the authentication fails, at block 240, then the transaction ends at block 255. Otherwise, the third-party institution sends the transfer request to the financial network at block 311. The transfer request may include instructions for debiting and crediting accounts at the first financial institution 130 and/or the receiving financial institution 160. The transfer request may include one or two ISO 8583 200 messages. The first financial institution 130 then verifies that there are sufficient funds in the first account to transfer to the second account at the receiving financial institution 160 at block 321. If there are not sufficient funds in the first account at the first financial institution 130 then the transaction ends at block 255. If there are sufficient funds in the first account at the first financial institution 130 then the funds are debited from the first account at block 260. The funds are then credited to the second account at the receiving financial institution 160 at block 270. A net settlement may occur at the financial network host computer whereupon the first financial institution and the receiving financial institution are debited and credited according to their net fund transfers. The consumer 110 may then receive a confirmation that the funds have been transferred at block 280.

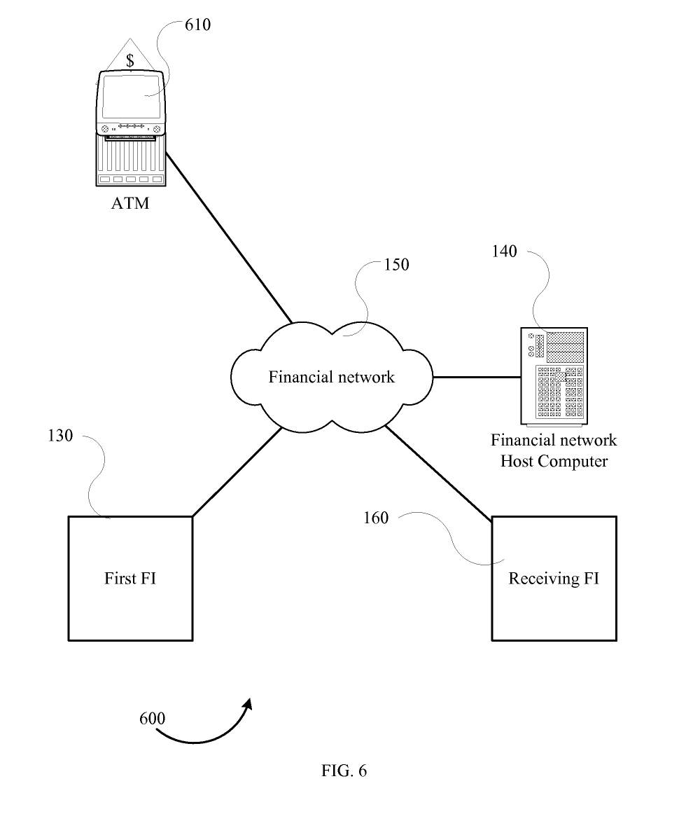

FIG. 6 shows a block diagram 600 of a fund transfer system using an ATM 610 according to another embodiment of the invention. In this embodiment, the ATM 610 is coupled directly to the financial network 150 and may be used to authenticate a consumer and transfer funds between a first account at a first financial institution 130 and a second account a receiving financial institution 160.

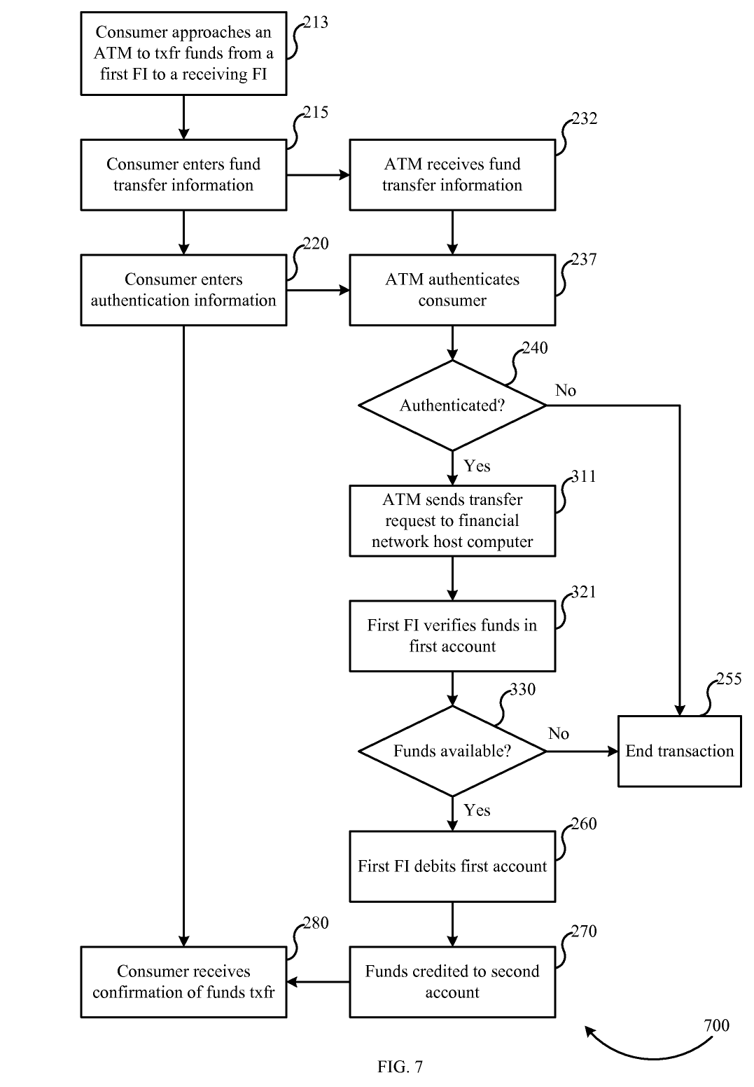

FIG. 7 shows a flowchart of a fund transfer process 700 using an ATM 610 according to another embodiment of the invention. This flow chart 700 is similar to the flow chart 500 discussed in regard to FIG. 5. In this flowchart 700, an ATM is used as the third-party institution. A consumer 110 approaches an ATM 610 to transfer funds from a first account at a first financial institution 130 to a second account at a receiving financial institution 160 at block 213. The consumer 110 enters fund transfer information at block 215, including, for example, account numbers, financial institution information, routing numbers, account holder names, and/or fund transfer amount. This information is received by the ATM at block 232. The ATM owner may also charge a fee to the consumer, and require payment of the fee at anytime. Payment of the fee may also be deducted from the first and/or second account The consumer may then enter authentication information at block 220, which is received at the ATM at block 237. The consumer may be prompted for this authentication information by the ATM. Authentication may included communicating with the first financial institution 130, the receiving financial institution 160, and/or the financial network host computer 140 for authentication.

If the authentication fails, at block 240, then the transaction ends at block 255. Otherwise, the ATM sends the transfer request to the financial network at block 311. The ATM may also send the transfer request to the first financial institution and the receiving financial institution. The transfer request may include instructions for debiting and crediting accounts at the first financial institution 130 and/or the receiving financial institution 160. The transfer request may include one or two ISO 8583 200 messages. The first financial institution 130 then verifies that there are sufficient funds in the first account to transfer to the second account at the receiving financial institution 160 at block 321. If there are not sufficient funds in the first account at the first financial institution 130 then the transaction ends at block 255. If there are sufficient funds in the first account at the first financial institution 130, then the funds are debited from the first account at block 260. The funds are then credited to the second account at the receiving financial institution 160 at block 270. A net settlement may occur at the financial network host computer. The consumer 110 may then receive a confirmation that the funds have been transferred at block 280.

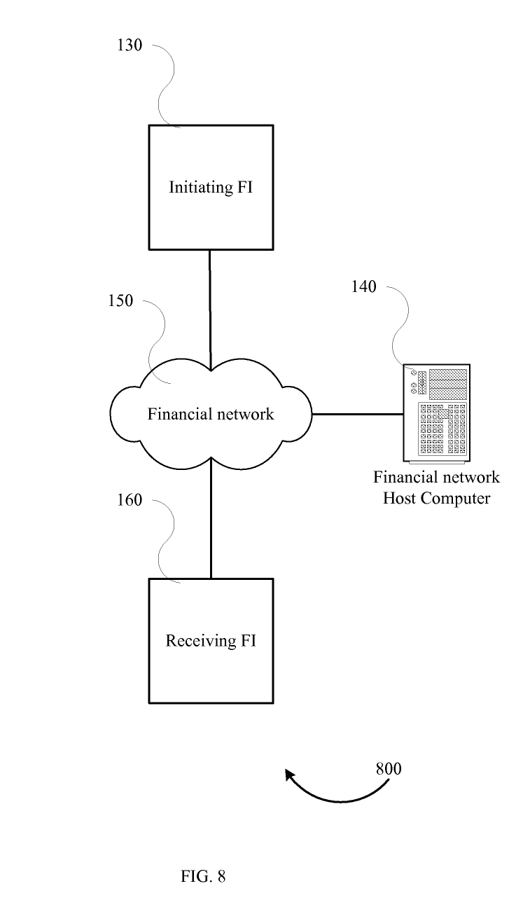

FIG. 8 shows a block diagram of a fund transfer system 800 initiated at an initiating financial institution 130 over a financial network 150 according to one embodiment of the invention. An initiating financial institution 130, a receiving financial institution 160, and a Financial network host computer 140 are connected to a financial network 150. Fund transfers from the initiating financial institution 130 may be initiated by a teller at the initiating financial institution 130. The teller may initiate the fund transfer at the request of a consumer. The consumer may request the fund transfer in person, over a telephone, through the Internet or through the mail. As with the other embodiments of the invention, appropriate verification and authentication may be required to ensure that the consumer is authorized to transfer funds from the first account at the initiating financial institution 130.

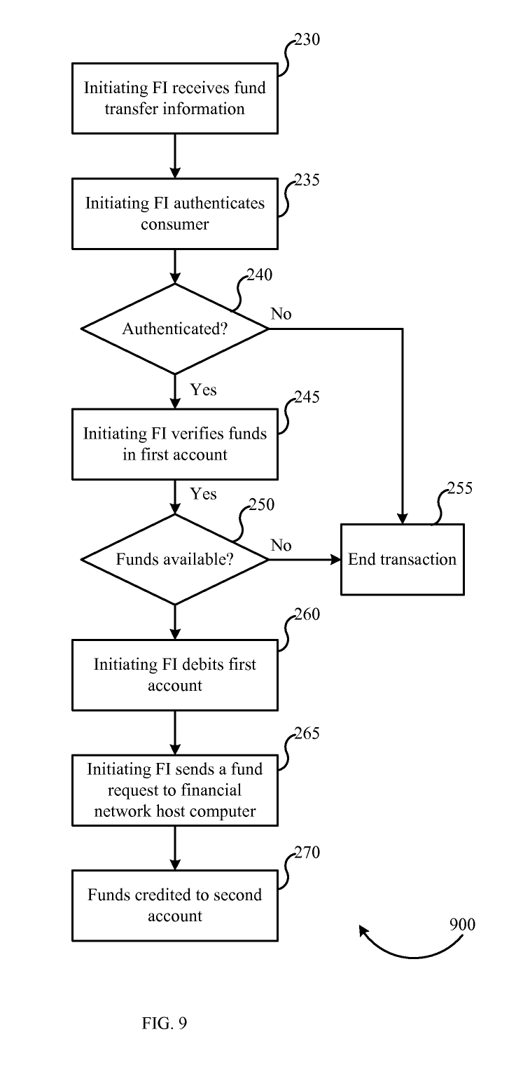

FIG. 9 shows a flowchart of a fund transfer process 900 according to another embodiment of the invention. The initiating financial institution 130 receives fund transfer information at block 230 and authenticates the consumer for transactions involving the first account at block 235. If the authentication fails, at block 240, the transaction ends at block 255. If the authentication is successful, the initiating financial institution 130 verifies that the first account has sufficient funds for the fund transfer at block 245. If funds are not available at block 250, the transaction ends at block 255. If there are sufficient funds available, the first account at the initiating financial institution 130 is debited the amount of funds in the fund transfer request at block 260. The initiating financial institution 130 may send a fund transfer message to the host network computer system over the financial network 140 at block 265 that initiates a net settlement. The funds are then credited to the second account at the receiving financial institution 160 at block 270.

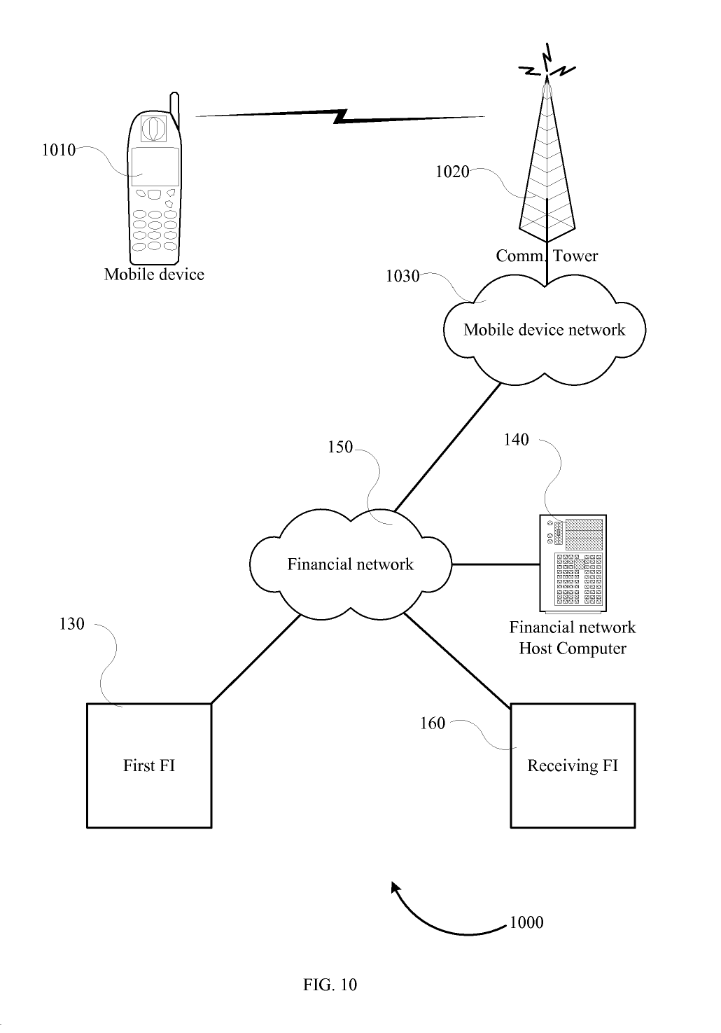

FIG. 10 shows a block diagram of a fund transfer system 1000 using a mobile device 1010 according to one embodiment of the invention. The mobile device 1010 is wirelessly connected with a mobile device network 1030 through a communication receiver, such as, for example, a communication tower, 1020. The mobile device network 1030 is coupled to the financial network 150. In another embodiment, one network may include the mobile device network 1030 and the financial network 150. A financial network host computer 140, a first financial institution 130 and a receiving financial institution 160 may be connected with the financial network 150. The mobile device 1010 may be used to initiate a fund transfer between the first financial institution 130 and the receiving financial institution 160. The mobile device 1010 may also be used to authenticate the consumer for the fund transfer. The mobile device 1010 may be a mobile phone, music player, personal data assistant, and/or a smart phone. By using the mobile device 1010, a consumer may transfer funds from, for example, a savings account at a bank to a checking account at a credit union.

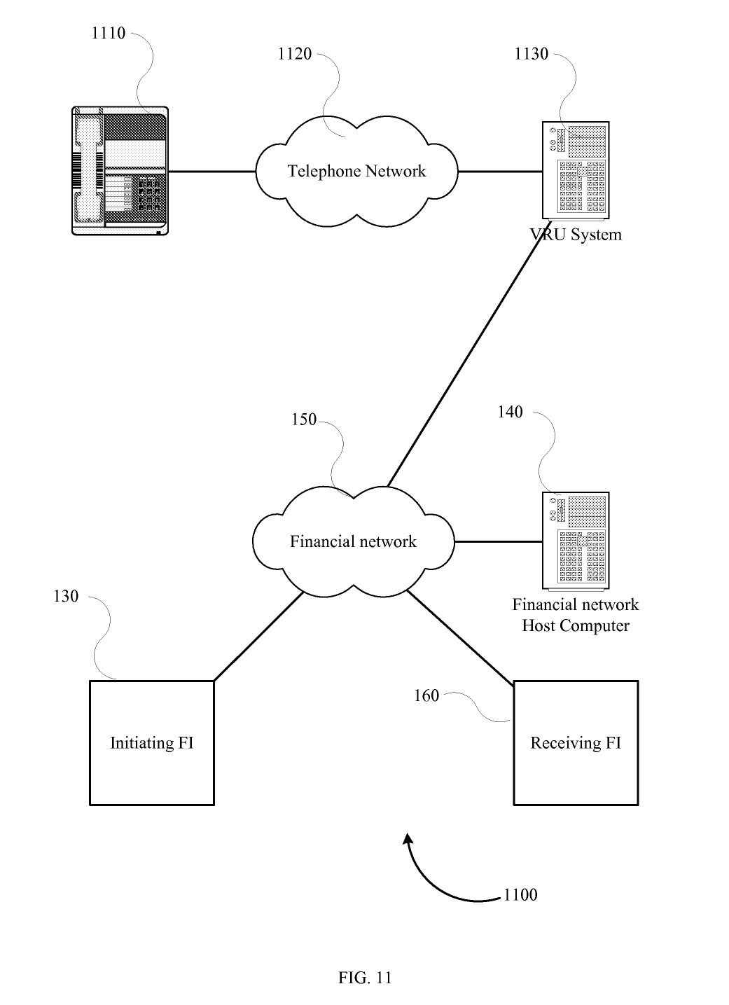

FIG. 11 shows a block diagram of a fund transfer system 1100 using a telephone 1110 according to one embodiment of the invention. The telephone 1110 is connected to a telephone network 1120. The telephone network 1120 is connected to an interactive voice response (IVR) system 1130 or voice response unit (VRU). The IVR system 1130 may use a voice recognition system to communicate with a consumer. The telephone network 1120 may be a public switched telephone network (PSTN) or other telephone network. A consumer may access the IVR system 1130 using a telephone 1110 through the telephone network 1120 to initiate a fund transfer over the financial network between the first financial institution 130 and the receiving financial institution 160.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

While the principles of the disclosure have been described above in connection with specific apparatuses and methods, it is to be clearly understood that this description is made only by way of example and not as limitation on the scope of the disclosure.

What is claimed is:

1. A computerized method for transferring funds from a first account at an initiating financial institution to a second account at a receiving financial institution over an electronic funds transfer (EFT) network, the method comprising:
receiving a funds transfer request from a consumer, wherein the funds transfer requests comprises a request to transfer funds from the first account at the initiating financial institution to the second account at the receiving financial institution, the fund transfer request comprises a fund transfer amount, and the funds transfer request is received from the consumer over the Internet;
authenticating the consumer for a transaction related to the first account at the initiating financial institution;
verifying that the funds available in the first account at the initiating financial institution is greater than or equal to the fund transfer amount;
debiting the fund transfer amount from the first account at the initiating financial institution; and
crediting the fund transfer amount to the second account at the receiving financial institution.

2. The method for transferring funds according to claim 1, wherein the EFT network is an automated teller machine (ATM) network.

3. The method for transferring funds according to claim 1, wherein the funds transfer request includes information identifying the second account at the receiving financial institution.

4. The method for transferring funds according to claim 1, further comprising sending the funds transfer request to a financial network host computer system.

5. The method for transferring funds according to claim 4, further comprising receiving, at the initiating financial institution and the receiving financial institution a net settlement from the financial network host computer system.

6. The method for transferring funds according to claim 1, further comprising sending a message to the consumer that the fund transfer was completed.

7. The method for transferring funds according to claim 1, wherein the fund transfer request is received at a financial institution selected from the group consisting of the initiating financial institution, the receiving financial institution, and a third-party financial institution.

8. The method for transferring funds according to claim 1, wherein the authenticating the consumer for a transaction related to the first account at the initiating financial institution comprises an authentication scheme selected from the group consisting of receiving a biometric sample; receiving a password, receiving a private key, receiving a public key, and receiving an operating system scan.

9. The method for transferring funds according to claim 1, wherein the authenticating the consumer for a transaction related to the first account at the initiating financial institution comprises authentication without using a personal identification number (PIN).

10. The method for transferring funds according to claim 1, wherein the first account at the initiating financial institution comprises an account associated with a card selected from the group consisting of a debit card, a stored value card, and an ATM card.

11. The method for transferring funds according to claim 1, wherein the fund transfer occurs over a financial network.

12. The method for transferring funds according to claim 11, wherein the financial network comprises a network selected from the group consisting of the STAR network, the NYCE network, and the PULSE network.

13. The method for transferring funds according to claim 1, wherein a consumer sends a funds transfer request from a device selected from the group consisting of an ATM, a mobile device, a mobile phone, a smart phone, a computer, a telephone, a kiosk, and a teller at a financial institution.

14. The method for transferring funds according to claim 1, further comprising sending a net settlement to the initiating financial institution.

15. The method for transferring funds according to claim 1, further comprising sending a net settlement to the receiving financial institution.

16. The method for transferring funds according to claim 1, wherein the funds are transferred using a financial network.

17. A computerized method for transferring funds from a first account at an initiating financial institution to a second account at a receiving financial institution over a financial network, the method comprising:
receiving a funds transfer request over a telephone network from a consume at a third-party institution system, wherein the funds transfer requests comprises a request to transfer funds from the first account at the initiating financial institution to the second account at the receiving financial institution, and the fund transfer request comprises a fund transfer amount;
authenticating the consumer for a transactions related to the first account at the initiating financial institution at the third-party institution;
requesting verification from the initiating financial institution that the funds available in the first account at the initiating financial institution is greater than or equal to the fund transfer amount;
requesting that the fund transfer amount is debited from the first account at the initiating financial institution; and
requesting that the funds transfer amount be credited to the second account at the receiving financial institution.

18. The method for transferring funds according to claim 17, wherein the telephone network using an interactive voice response (IVR) system.

19. The method for transferring funds according to claim 17, further comprising sending a message to the consumer that the fund transfer was completed.

20. The method for transferring funds according to claim 17, wherein the authenticating the consumer for a transaction related to the first account at the initiating financial institution comprises an authentication scheme selected from the group consisting of receiving a biometric sample; receiving a password, receiving a private key, receiving a public key, and receiving an operating system scan.

21. The method for transferring funds according to claim 17, wherein the authenticating the consumer for a transaction related to the first account at the initiating financial institution comprises authentication without using a personal identification number (PIN).

22. The method for transferring funds according to claim 17, wherein the first account at the initiating financial institution comprises an account associated with a card selected from the group consisting of a debit card, a stored value card, and an ATM card.

23. The method for transferring funds according to claim 17, wherein the fund transfer occurs over a financial network.

24. The method for transferring funds according to claim 23, wherein the financial network comprises a network selected from the group consisting of the STAR network, the NYCE network, and the PULSE network.

25. A computerized method for transferring funds from a first account at an first financial institution to a second account at a receiving financial institution over an electronic funds transfer (EFT) network, the method comprising:
receiving a funds transfer request from a consumer at a third-party financial institution, wherein the funds transfer requests comprises a request to transfer funds from the first account at the first financial institution to the second account at the receiving financial institution, the fund transfer request comprises a fund transfer amount, and the funds transfer request is received at the third-party institution from the consumer over the Internet;
authenticating the consumer at the third-party institution for a transaction related to the first account at the first financial institution;
verifying that the funds available in the first account at the first financial institution is greater than or equal to the fund transfer amount;
debiting the fund transfer amount from the first account at the first financial institution; and
crediting the fund transfer amount to the second account at the receiving financial institution.
